(19) United States
(12) Patent Application Publication
(10) Pub. No.: US 2005/0010918 A1
(43) Pub. Date: Jan. 13, 2005

(54) Autonomic image migration/deployment appliance

(75) Inventors: Philip Lee Childs, Raleigh, NC (US); Michael T. Vanover, Raleigh, NC (US); Steven R. Welch, Giltoy, CA (US); Ted Bonkenburg, Mountain View, CA (US); Dejan Diklic, Saratoga, CA (US)

Correspondence Address: KELLY K. KORDZIK;WINSTEAD SECHREST & MINICK PC, PO BOX 50784, DALLAS, TX, 75201, US

(73) Assignee: International Business Machines Corporation, Armonk, NY (US)

(21) Appl. No.: 10/618,181

(22) Filed: Jul. 11, 2003

(51) Int. Cl. G06F 9/445

(52) U.S. Cl. 717/174; 717/168; 717/176

(57) ABSTRACT

A system and method for the migration and distribution of computer software using an appliance which non-invasively creates copies of computer files from a data set and installs them on destination computers. The system and method features several ways of configuring the software installed for its reliable operation in the new hardware environment. Also disclosed is a system and method for the manipulation of data set files in order to optimize and pre-configure them for the new hardware environment.

### RELATED APPLICATIONS

This application is related to U.S. application Ser. No. ______, entitled, “Autonomic Non-Invasive Backup and Storage Appliance,” filed contemporaneously herewith.

### TECHNICAL FIELD

The instant invention relates in general to a system and method for the distribution of a set of software onto a computer system. The invention is well-suited to software system distribution and to address hardware migration needs.

### BACKGROUND

Within the prior art, distribution or migration of a computer software system essentially comprises making a partial backup of an existing system and performing strategic restoration on a new system. This process requires relatively large backup software programs (15-25 MB) to make an image of a source computer's system storage media or to copy the files from the source computer. That image or those files are then distributed or migrated to the destination hardware storage media. Examples of the programs used to effect these operations typically include those programs offered by XPOINT TECHNOLOGIES and POWERQUEST, each very popular in the art. Installation of these types of programs generally have extensive installation side effects, such as the resizing or creation of partitions on the main system storage media and/or extensive modifications to the computer operating system. These installation side effects can cause incompatibilities with other installed software, can diminish available resources for other computer functions, and makes the installation process more complicated for a user to accomplish. Moreover, when partial backups are used, user error and omission in the selection and restoration of files leads to wasted time conducting supplemental migrations and installations in order to complete the new system.

Additionally, the state of the art backup programs do not present a very flexible model of migration. Few systems are file based; most are image based. Regardless, it is very difficult to make changes to the backed up data and therefore very difficult to ensure the proper operation on a new computer, unless identity of systems is maintained. Moreover, any viruses or inefficiencies that were present in the old computer are transferred during the backup/restoration process to the new system.

Networked distribution is accomplished in the prior art one of two ways. Under the first model, an extensive agent resides on the node computer system, managing the data interactions with a relatively simple server software on the network server. Under the second model, a smaller agent resides on the node, requiring more extensive server software on the network server to fully manage the data storage functions. Under either model, modifications to the node computer system are required, creating side effects similar to those seen with the backup and migration systems. For proper operation, the network storage systems often require the allocation of storage space to the node network agent program and the modification of the operating system on the node. These side effects result in the same compatibility, storage and complexity issues seen with backup and migration systems.

Both the migration and the distribution functionalities present significant expense to the user desiring to effectively use them. In addition to the expense of acquiring the software for migration and for distribution, each requires additional hardware resources, installation expense and user training.

### SUMMARY OF THE INVENTION

The instant invention provides an appliance which is suitable for the migration of a computer system and which may also be used to distribute software repeatedly and selectively within a business organization. The instant invention features the simplicity of a plug-and-play type technology yet the power to be able to be used within large organizations effectively. As a result, the instant invention provides the unexpected benefits of an easier, more cost-effective migration and mass distribution model.

The foregoing outlines broadly the features and technical advantages of the present invention in order that the detailed description of the invention that follows may be better understood. Additional features and advantages of the invention will be described hereinafter which form the subject of the claims of the invention. The instant invention offers many advantages over these prior art systems, and presents several additional benefits that will be apparent to the reader skilled in the art.

### DESCRIPTION OF THE DRAWINGS

A more complete description of the instant invention is made with reference to several figures:

FIG. 1 is a system diagram depicting a computer hardware system and its configuration when used in the instant invention;

FIG. 2 is a system diagram depicting an embodiment of the hardware configuration of the instant invention when used for system migration;

FIG. 3 is a system diagram depicting an embodiment of a network hardware configuration of the system distribution aspect of the instant invention;

FIG. 4 is a flow chart drawn in conformance to the ANSI/ISO 5807-1985 specification and depicting migration and data storage creation operations under the instant invention;

FIG. 5 is a flow chart drawn in conformance to the ANSI/ISO 5807-1985 specification, continuing the flow chart of FIG. 4 and depicting restoration and distribution operations under the instant invention;

FIG. 6 is a block diagram depicting the composition and use of the storage address generator in accordance with the instant invention;

FIG. 7 is a system diagram depicting an embodiment of a diversified network hardware configuration of the instant invention; and

FIG. 8 is a data diagram depicting the distribution of the various types of files under system distribution in the instant invention.

FIG. 9 is a flow chart drawn in conformance to the ANSI/ISO 5807-1985 specification showing the optimization and updates to the data file that may be conducted during a migration in conformance with the instant invention.

### DETAILED DESCRIPTION

In the following description, numerous specific details are set forth such as computer programming languages, database structures, computer operating systems, microprocessors, bus systems, integrated circuits, protocols, input/output (I/O) systems, etc., to provide a thorough understanding of the invention. However, it will be obvious to those skilled in the art that the present invention may be practiced without such specific details. In other instances, well-known protocols, data formats, computer equipment, and I/O systems have been shown in block diagram form in order to not obscure the present invention in unnecessary detail. For the most part, details concerning timing considerations, specific languages used, specific database structures used, specific data formats used, and the like have been omitted inasmuch as these details are not necessary to obtain a complete understanding of the present invention and are well within the skills of persons of ordinary skill in the art.

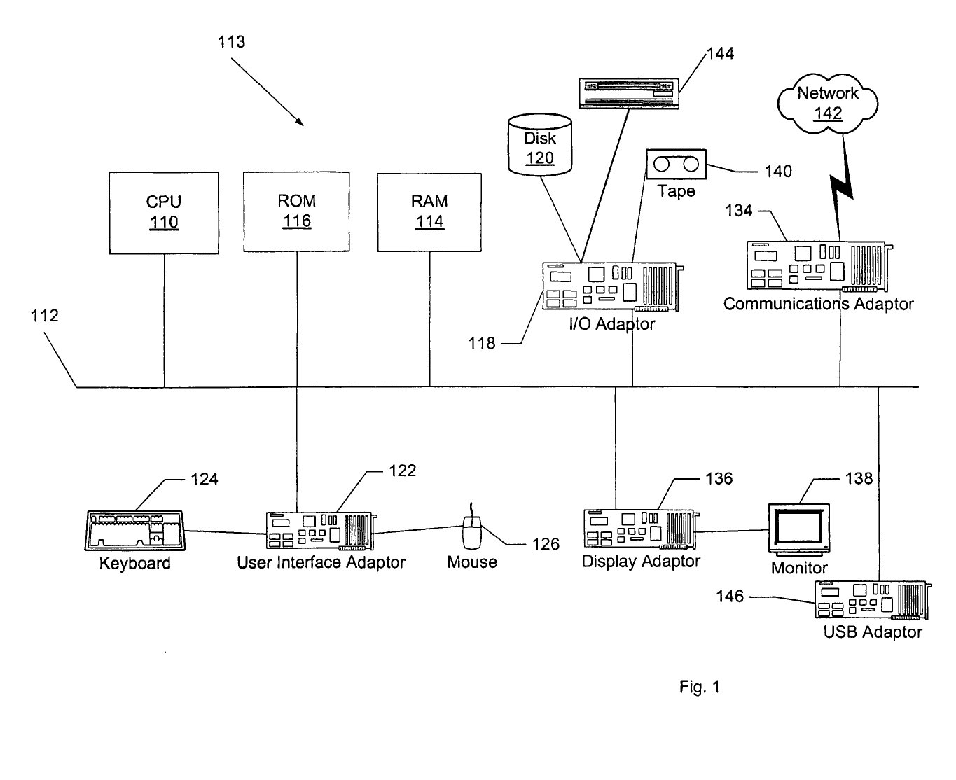

A representative computer hardware environment for practicing the present invention is depicted with reference to FIG. 1, which illustrates a hardware configuration of a data processing system 113 in accordance with the subject invention. The data processing system 113 includes a central processing unit (CPU) 110, such as a conventional microprocessor, and a number of other units interconnected via a system bus 112. The data processing system 113 includes a random access memory (RAM) 114 and a read only memory (ROM) 116. Those skilled in the art will appreciate that the ROM 116 could be replaced or supplemented by a number of semi-permanent chip-based storage devices, such as programmable read-only memory (PROMs), erasable programmable read-only memory (EPROMs), and the like (not shown). Also included are an I/O adapter 118 for connecting peripheral devices such as disk units 120, tape drives 140 and CD or DVD drives 144 to the bus 112, a user interface adapter 122 for connecting a keyboard 124, a mouse 126 and/or other user interface devices such as a touch screen device (not shown) to the bus 112, a communication adapter 134 for connecting the data processing system 113 to a data processing network 142, and a display adapter 136 for connecting the bus 112 to a display device 138. Also, a universal serial bus (USB) adapter 146 may be fitted to the bus 112. The CPU 110 may include other circuitry not shown herein, which will include circuitry found within a microprocessor, e.g. execution unit, bus interface unit, arithmetic logic unit (ALU), etc. The CPU 110 may also reside on a single integrated circuit (IC).

The representative hardware environment depicted in FIG. 1 may be suitable to execute the system to be described. It will be understood that references to a “computer” in this disclosure are to a hardware system similar to that depicted and described with reference to FIG. 1. Those skilled in the art will appreciate that the description with reference to FIG. 1 contains many of the elements common to a computer hardware system, but that a computer hardware system may be operable without every element described in FIG. 1. Accordingly, references to a “computer” may exclude elements disclosed, so long as functionality is maintained. Similarly, modifications and additions may be made to the hardware system, all falling within the definition of “computer” within this specification.

It will be appreciated that the computer disclosed herein is suitable to execute client-side and server-side applications in client-server environments. In such environments, certain adaptations may be made to each computer in order to maximize efficiencies in these respective roles. Further, it will be apparent to those skilled in the art that certain of the computers referenced may be embodied in one or several of the computers as depicted in FIG. 1. Several computers may operate in parallel or in series, filling the function of a single computer and in some cases achieving greater efficiencies.

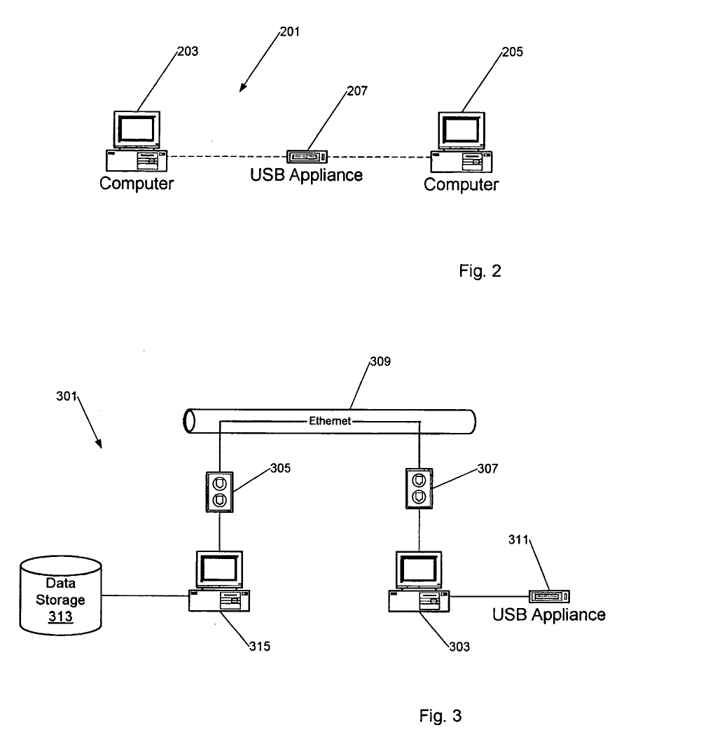

The basic operation and hardware configuration of the instant invention for migration is described with reference to FIG. 2. FIG. 2 depicts a migration 201 in conformance with the present invention. The migration 201 occurs in order to transfer the operating system, other software and data from an old, source computer 203 to a new, destination computer 205. First, the old computer 203 is electrically connected to a migration appliance 207. The migration appliance 207 may be one of several types of appliances. Shown is a USB appliance 207, connectable to the old computer system 203 via a USB interface. The USB appliance 207 is configured so as to appear as a disk drive to the computer 203. A migration program, of the type and configuration described herein, is stored within the appliance 207.

The appliance 207 may be one of several types of appliances, so long as the appliance 205 is capable of read/write storage. The shown USB appliance 207 may be replaced by a Read/Write CD drive, connectable to the computer 203 by means of a typical I/O interface, such as an Integrated Drive Electronics (IDE) interface or a Small Computer System Interface (SCSI). Similarly, other read/write devices may be used as the appliance.

Generally, pursuant to the invention, the migration program resident on the appliance 207 directs the computer 203 to copy the files from its hard drive storage system onto the appliance 207. This method of operation is in stark contrast to the prior art, under which a backup program would be installed on the computer 203 which would then instruct the computer 203 to copy data from the computer 203 hard drive to a data storage appliance 207.

Once the operation is complete, the contents of the hard drive of the old computer 203 may be manipulated by the program contained on the appliance 207. Such manipulations may include, without limitation, virus scans, the addition of new drivers required for the operation of the new computer system, or optimizations to the file positioning and structure. Once the manipulations are complete, the appliance 207 is removed from the old computer 203 and attached to the new computer 205.

On the new computer, the program stored within the appliance 207 directs the computer 205 to copy data from the appliance 207 to the new computer 205. When the new computer 205 reboots, it presents the fully-migrated software system.

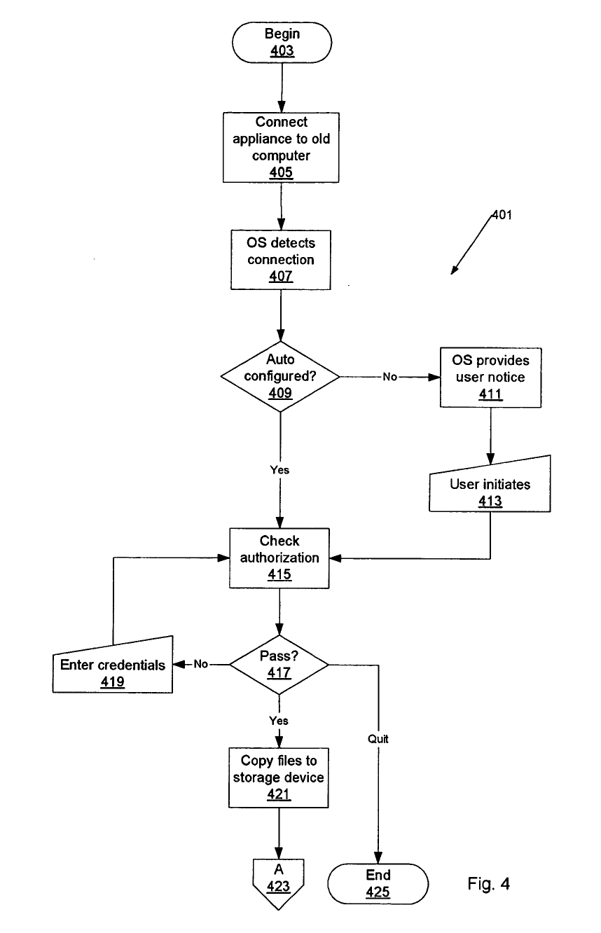

A hardware configuration of the instant invention in a distribution environment is show with reference to FIG. 3. FIG. 3 shows a network system 301 having a new computer 303 on which a system is to be installed. The computer 303 is in electrical connection with a network port 307, which is in turn in electric communication with a network 309. Although the network 309 shown is nominated as an Ethernet network and in block form, those skilled in the art will appreciate that the type and configuration of the network is irrelevant to the operation of the instant invention. Accordingly, the invention could be practiced on any number of network systems, including a token ring system or a system having wireless, hubbed or routed components, without changing the effect of the invention, and all falling within the scope of the disclosure.

The network 309 provides data communication from the computer's port 307 to a second port 305. In electric communication with the second port 305 is a host computer 315. The host computer 315 may be another computer on the network 309 similar to the new computer 303 or in the alternative may be a computer that is optimized to operate as a server on the network 309.

Under the present invention, a distribution appliance 311 is placed in data communication with the new computer 303 (in the same manner as illustrated as to elements 203 and 207 with regard to FIG. 2). The program appliance contains a distribution program that is similar in operation to the migration program previously described, except that rather than copying the stored data from the appliance 311 to the new computer 303, the appliance 311 directs the new computer 303 to download the files over the network 309 from a data storage device 313 that is in data communication with a server computer 315.

As was disclosed with reference to FIG. 2, the appliance 311 is shown as a USB appliance, but may be any number of different types of appliances, ranging from USB drives, CD drives, read/write CD drives, and the like. Additionally, it will be appreciated by those skilled in the art that although the data storage 313 is shown as a hard drive connected to the server 315, it may similarly be any type of data storage device, including those listed above (though write capabilities will be required for the creation of the original data to be used). In this embodiment of the invention, it is more likely that the host machine 315 is configured particularly as a server, so as to provide the large storage space and communications buffers which would maximize performance.

It will be appreciated that the use of the invention in the network hardware environment 301 permits the appliance 311 to be moved from the subject computer 303 to other computers (not shown) connected to the network with relative ease. Accordingly, distribution to many computers on a network 309 may be accomplished without the need for installation of backup software on any of the computers 303 nor the host/server computers 315 with programs which might corrupt, modify or interfere with the proper normal operation of those computers 303, 315.

The operation of the writing functions of the program appliance 311 are shown in more detail with reference to FIG. 4. FIG. 4 depicts the method 401 of write operations, which are used to create the data from a source computer. Operations begin 403 with the precondition of a computer system having a hard drive or other media that is to be the source for the system. First, the program appliance is connected 405 to the source computer. Upon such connection, the operating system of the computer detects the connection 407. The means for detecting the connection of a new media device are well known in the art, and are typified by the plug-and-play capabilities of operating systems such as Windows XP.

Many operating systems provide not only for detection 407 of the new media made available to a computer, but also provide for the automatic execution of programs placed in specific locations within that media. For example, under Windows XP, inserting a new CD or attaching a new USB drive will cause Windows XP to seek and execute the commands located in the AUTORUN.INF file. By equipping the program appliance with an AUTORUN.INF file in its root directory, the insertion of the new media causes the automatic execution of the migration/distribution program resident on the appliance.

Upon the execution of the program resident on the appliance, first the evaluation is made as to whether the program appliance is configured for fully-automatic operation 409. Those skilled in the art will appreciate that this evaluation may be made any number of ways. The appliance program may query the operating system and/or the microprocessor in order to determine the serial number of the machine, comparing that number against a table of configuration parameters, in order to determine whether automatic operation is enabled. In an alternative embodiment, the user may be queried as to whether automatic operation is desired. In yet an alternative embodiment, files may be stored on the source computer which indicate certain preferences as to the automatic operation of the appliance. Note, however, that the embodiment which places configuration files on the source computer would no longer provide a system which operated without interfering with the hard drive on the source computer. In an alternative embodiment, this evaluation may be skipped, the choice being hard coded into the operation of the program.

If the program is not set for automatic execution, then the program has the operating system provide 411 notice to the user of the manner in which execution may be activated. Notice may come in several forms. In one embodiment, an icon is provided in a toolbar or desktop. In another embodiment, the user may be provided dialog boxes with instructions on how to activate the program for the data creation procedure. In any event, the program operation halts or discontinues until such time as the user manually activates 413 the program. Activation may be by clicking or double-clicking an icon, typing a keyboard command or any other means of signaling the computer to begin or continue a program.

Once the user initiates 413 or, if automatic operation was enabled 409, immediately, the program first checks with the operating system to ensure that the user has sufficient authorization rights to make a full copy of the computer system files. Typically, operating systems will lock sensitive or system-critical files from the direct access of the normal user. Generally, supervisor or administrator rights, at least as to the local system, will be required in order to make proper access to those system files for copying to any backup or alternate storage media. After inquiry as to the level of access is made, that level of access is checked 417 to ensure that it is sufficient to permit a full copy of the source software.

If sufficient authorization is not inherent in the user's login credentials, the user is prompted 419 to enter sufficient credentials to permit access of all of the system files, at least on a read-only basis. Once those credentials are entered 419, they are again queried with the operating system 415 and evaluated to see if they are sufficient 417. The user may exercise the option, if he or she does not have sufficient credentials, to quit the program 425 without having made the copy.

If sufficient credentials are demonstrated, the program copies 421 the files from the hard drive of the subject computer onto the data storage medium. Files are copied on a file-by-file, rather than a bit-by-bit, basis. Accordingly, the files may be stored contiguously on the data storage medium and are retrievable individually or in groups without retrieving the entire copy. Thus the instant invention is in contrast to the prior art “ghosting” technology, which would create a image of a source machine that would need to be recreated in whole in order to be accessed. Those skilled in the art will appreciate that various compression technologies, well known in the art, including hardware and software-based technologies, may be used under the instant invention to condense the amount of space that the files occupy on the data storage medium.

During the copying 421 of the files from the hard drive to the data storage medium, the files may be flagged with the archive bit or similar file system bit, if the operating and/or file system is so equipped, to indicate that a copy of the file has been made. By using this bit, the system of the instant invention permits the well-appreciated art of incremental backup to be practiced as to the distribution of files across a corporate network. Under this schema, a full distribution may be made of a computer system initially. From that point, if updates are desired to be distributed, a process akin to an incremental backup is performed, which only makes copies of the files that have changed since the last copy was made of the source computer. In this way, updates may be distributed over a large area very quickly and easily, without the need for re-imaging or re-copying the entire system.

It will further be appreciated that the process of copying the computer data to the data storage appliance may, in an embodiment, also make note of the identity of the data files, the source machine and/or time of creation. This information allows the distinguishing of several sets of data files.

The writing portion of the migration/distribution operation 401 ends with control passed 423 to the reading portion of the program.

In the normal case, however, the completion of the creation operation 401, if configured for automatic operation and initiated by someone with supervisor credentials, provides the single-step manufacture (absent any errors) of a distribution model or the single step reading of an old system when used in conjunction with the hardware configurations previously described. Moreover, the instant invention provides for such a data set to be made without any modifications to the source computer and without the installation of any programs. Such a system provides several non-obvious benefits over the prior art, in which a backup or ghosting program is installed directly on the source computer.

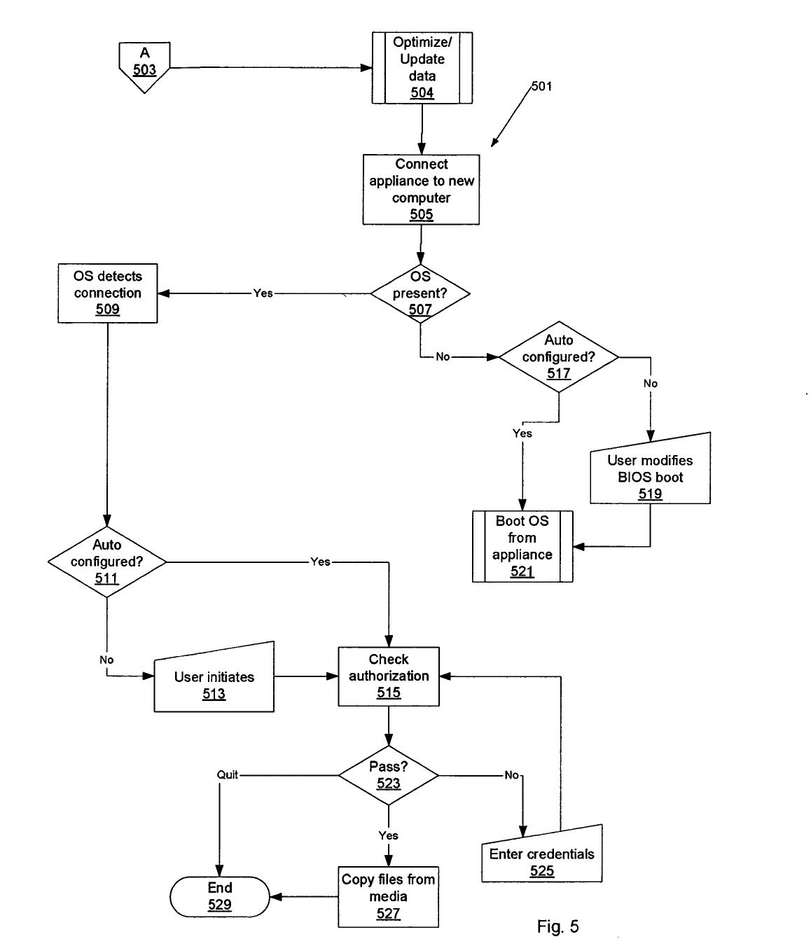

The restoration procedure is shown with reference to FIG. 5. FIG. 5 depicts the restore operation 501 in accordance with the instant invention which will be executed when the appliance is attached to either the new, replacement machine (in the migration embodiment) or in the new machine to which distribution is desired. The operation 501 begins 503 with the precondition of a data set having been made in accordance with the instant invention. It will be appreciated, however, that because the data set is made on a file-by-file basis, the data set may be easily modified by the sophisticated user. Accordingly, the data set need not be one that came directly from a source machine (although that would provide the simplest instance of the invention). Instead, the source machine data may be manually modified to provide for alternative distributions. In this way, it is possible that the data set represents an entirely new iteration of a system, never before having been present on a computer.

The first step, which may be performed after the writing process or, in an alternative embodiment, may be omitted entirely, is to optimize and update 504 the data set. As the data set is stored on a file-by-file basis, it may be optimized and updated by the program in order to make it more suitable to its new environment. Useful particularly (though not exclusively) in the migration context, these procedures provide features such as virus scanning and storage optimization, described with greater detail later herein.

Next, the user connects 505 the appliance to the new destination computer. Execution next depends upon the presence of an operating system 507, such as an operating system that might ship with a new computer. There may be other times when blank media is to accept the data set files, as when a hard drive is replaced within a system, and migration is to occur to a different hard drive on the same computer.

In the case of blank media, execution continues depending upon 517 whether the appliance system is set for automatic operation. This inquiry is based upon the availability of the ability of the BIOS in the new computer to boot from the appliance. If automatic operation configuration is set, the BIOS is set to boot from the appliance, if present. If not, user intervention 519 is required to properly configure the BIOS to enable a boot from the appliance. It is to be recalled that the appliance may be any number of devices, such as a USB device or CD drive. Accordingly, both the determination 517 of the proper auto configuration settings and the manual setting 519 of the BIOS parameters will vary from instantiation to instantiation of the instant invention, depending upon the nature of the appliance used.

Execution proceeds with the computer booting 521 an operating system from the appliance. Boot from the appliance causes the appliance to install a rudimentary operating system suitable to complete installation of the files from the data store. Following the installation of those files, and as part of the installation process, the computer reboots itself.

On reboot, the restore portion of the operation begins 503 again and follows the same execution path as previously, except that at the determination 507 of the presence of an operating system, the operation finds the installed operating system. Execution proceeds from that point as if an operating system had been found originally during the first iteration.

After an operating system is located 507, the operating system detects 509 the presence of the appliance. The result of detecting the appliance 509 is as previously described with reference to the writing procedure, namely that the operating system executes the AUTORUN.INF file or similar automatically-executing file from the media.

The next query made by the system is whether 511 the system is configured for automatic restoration. As with the data set creation procedure, the selection of automatic configuration may be a previously-made selection which is memorialized in data configuration files on the appliance. However, there may be instances when, for example if only a partial restoration is desired, full automatic restoration is not desirable. Accordingly, automatic restoration may be disabled, in which case the user must manually initiate 513 the restoration procedure. Such initiation 513 may occur in any of the several ways well-appreciated in the art, such as a command line directive or the clicking of an icon.

In either eventuality, execution proceeds to check 515 the authorization for restoration at the computer level. The authority of the user may be derived from the current operating system login or may be separately entered by the user. Alternatively, it may not exist at all, for example in the instance that a new instantiation of the operating system is created on the computer with only a generic login. The restoration authorization check 515 ensures that a user has the authority to overwrite the information on his or her hard drive. This authorization helps ensure, particularly in large organizations, that users do not unintentionally or maliciously destroy the contents of their hard drives.

The authorization is evaluated 523 to ensure it is of sufficient level to permit restoration. It will be appreciated that, if a full operating system is to be placed on the destination system, supervisor-level access will be needed in order to ensure that the operating system files may be overwritten. If access is not of a sufficient level, the user may be prompted 525 to enter additional or new credentials, which are in turn re-evaluated 515 and checked 523 to ensure that they meet the minimum levels required. Optionally, the user may be provided the option to terminate 529 the operation rather than to enter valid authorization credentials.

Once authorization is ensured, the system copies 527 the files from the appliance to the hard drive of the destination computer. It is anticipated that files will be copied on a file-by-file basis, rather than bit-by-bit. The file-by-file restoration process optionally permits a user to select the files are to be restored, allowing the installation of only a portion of the migration/distribution files, rather than the entire system. It will further be appreciated that the file-by-file basis allows restoration to be accomplished to a new hard drive, regardless of its similarity to the geometry of the old hard drive. Moreover, the file-by-file generates the side effect of a new system that automatically has a defragmented file system.

It will be appreciated that this file copying process may occur in several different manners and may use a great number of features already well known in the art. For example, the restoration procedure may restore compressed data set files by uncompressing those files to the hard drive. Each of these and many other backup/restore features well known in the art may be applied to the instant invented system.

The process ends 529 with the post condition of either a partially or fully-restored hard drive on the computer or an error condition (such as failure of authentication).

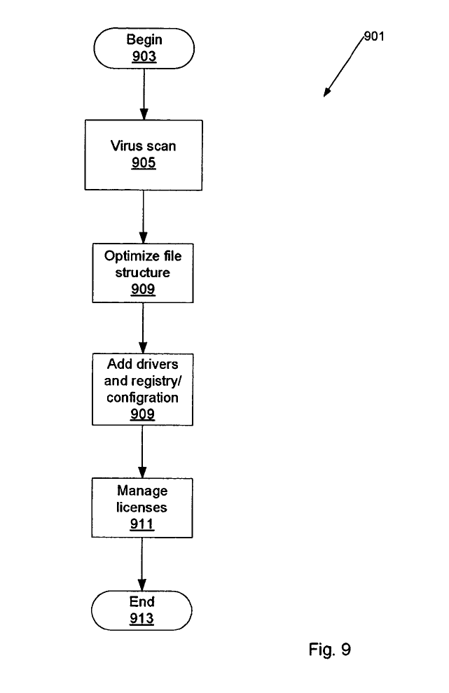

Detail of the process for optimizing/updating the data set 504 is shown with reference to FIG. 9. The process 901 begins 903 with the precondition of a data set that comprises the files from a computer system. As previously noted, portions of this process 901 may be particularly suited to either the migration or the distribution applications, as will be evident from this disclosure to those skilled in the art. Further, most if not all of the steps in this process 901 represent optional features, and the invention disclosed may be practiced without such features or benefits, all falling within the bounds of the invention. Similarly, the order of the procedures disclosed may be modified without affecting the overall operation of the invention.

The process scans 905 the data set files for viruses. The scanning for viruses itself may be by the means commonly found within the art, such as heuristics, signature matching and the like. As the files on the data set are accessible file-by-file, scanning may be done in the normal manner as would be done on a hard drive. If the data set is compressed, then decompression may be required in order to conduct the scan. If a virus is located, then the virus may be eliminated or repaired by the normal conventional means of deletion or quarantine of the offending file or modification to remove the malicious code. The system may annotate the storage address file (to be described hereinafter) within the data set to alert the user to the deletion or quarantine of a file.

The process 901 may also include an optimization 909 of the file structure. As has previously been noted, the process of effecting file-by-file copies of all of the files on a disk effectively defragments the files. However, the structure of the files may additionally be optimized, as is known in the art, by the placement of certain static files closer to the logcal front of the drive. Similarly, the order of subdirectories and files may be optimized to provide for greater efficiencies in the users' locating files on the destination hard drive. Such re-orderings may be accomplished either by the relocation of the files on the data storage or by the designation of a file order within the data set itself (particularly in the storage address file), so as to flag which files should be written first during a restoration process.

The data set may also be modified 909 to add drivers and to implement registry changes to the system to be written to the destination computer. It will be appreciated that, when migrating a system from a source machine to a dissimilar destination machine, different drivers will likely be required for the proper operation of the operating system. Similarly, when distributing a system made based on a source machine, dissimilar distribution destinations may cause similar challenges. With the instant invention, new drivers may be installed directly to the data set prior to its installation on the destination machine.

In a similar manner, and particularly (although not exclusively) in the distribution context, data sets for operating systems that use registries, such as Windows, and similar configuration files may be manipulated to make configuration files which are suitable for use on the destination system. It will be appreciated that, particularly in the context of a Windows registry, the customization of registry files may be accomplished under the instant invention in any one of several ways:

a) A registry or configuration file set may be constructed by “brute force,” generating one set of files for each possible permutation of operating system/hardware/application combinations. While this method is very simple to generate and very fast in execution, it requires a large commitment of space and can be a challenge to keep up to date.

b) A basic registry or configuration file set may be constructed for distribution, with the additions to those files to be effected by the installation procedures of the operating system and/or applications to be installed on the destination computer. Although the process of running the various installation routines following restoration of the data set to the destination computer may be automated, such a process may be very slow, particularly where a large number of applications are at issue. However, this process does result a small and extremely reliable installation.

c) Alternatively, a basic registry or configuration file may be constructed for distribution, along with a supplemental configuration file which can be added to the registry or configuration file after its placement on the destination computer. While this process is very fast and can be very efficient, it does require that a supplemental registry or configuration file be present for every application. It also generally does not work well for constantly-changing applications.

d) In another embodiment, the registry and configuration files distributed or migrated may contain all of the entries required for every possible application on the new computer. After distribution or migration, the unneeded entries in the registry and configuration files may be uninstalled by the uninstall procedures distributed with the various softwares. This configuration has the advantage of having above-average speed with a high degree of reliability.

e) Similarly, a full registry and configuration file set may be distributed or migrated, only to later make strategic deletions in order to disable those portions of the registry or configuration files which are not required. This process does leave the registry somewhat cluttered with unused material, but it renders a fairly reliable and quickly-installed system.

f) In a final embodiment, some combination of the foregoing a)-e) may be used. For example, a registry may be distributed which includes only certain popular applications. Additional applications may be installed or their registry entries added. Popular applications not used in a certain circumstance may be deleted from the registry. By strategically selecting the applications which are provided for in the original installation of the registry and configuration files and by then strategically selecting which method of modification to use, the installation process may be optimized both for time and space allocation concerns.

Each of the foregoing methods of registry or configuration file generation is described hereinafter with reference to the paragraph letters a) through f) above.

As an additional optional element, the invention may manage 911 the license transition or distribution. Whenever software or a system is to be migrated or distributed, issues may arise as to the licensing of the software on the computer. In order to comply with all license requirements, the instant invention may provide for the disabling of software on a source machine prior to its being moved to a destination machine, if migration is being done. On the other hand, if distribution is being performed in a network environment, the invented system may make note of the use of an additional copy of particular software in a database designed to manage the licenses owned by an organization. In one embodiment, such a database may be configured as to disallow distribution if no licenses are available, thus saving the user from costly infringement and breach of license litigation. The exact form and operation of such a database is not disclosed, as it may be implemented in any of several ways well-appreciated in the art and fully enabled by the foregoing discussion.

The subroutine ends 913 with the post condition of the data set having been optimized and configured for the specific machine onto which it will be installed.

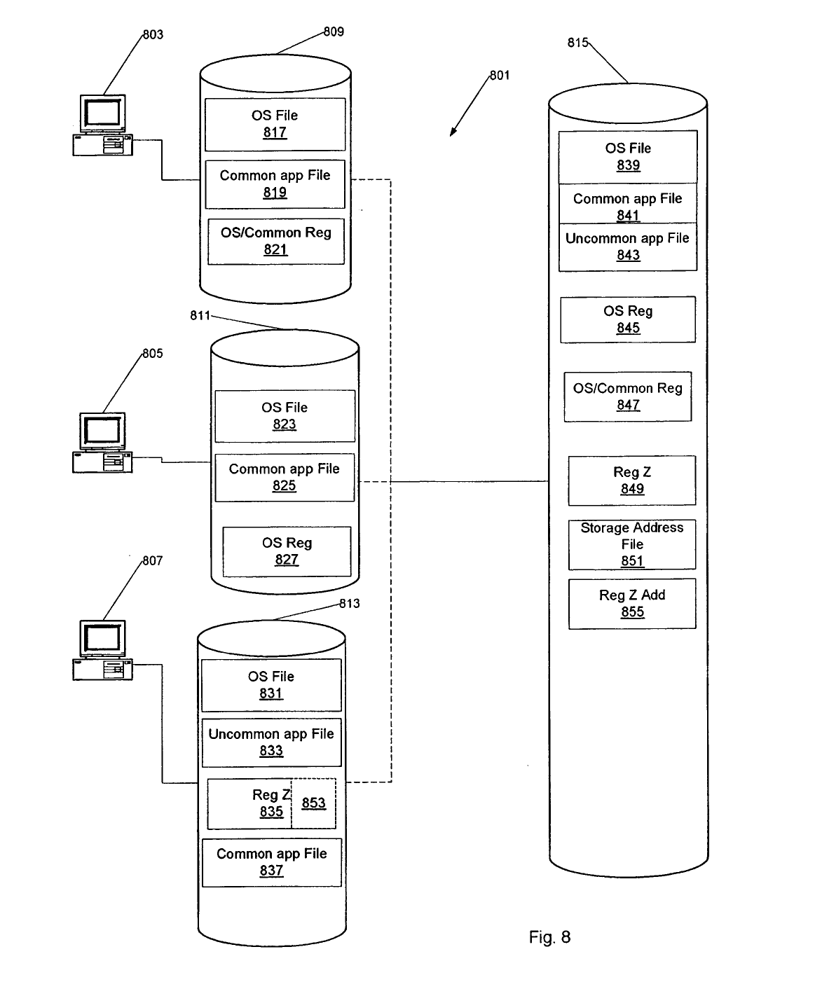

An example of the foregoing configuration and registry file distributions under the present invention is shown with reference to FIG. 8. FIG. 8 discloses an example 801 of the data storage unit 815 optimized for use in software distribution (including registry and configuration files) to a set of computers 803, 805, 807 according to the instant invention. The storage unit 815 contains the files suitable for distribution and created as described previously herein. Though the files 839, 841, 843, 845, 847, 849, 855 are identified singularly, it will be appreciated that any one of them could be substituted with a set of files without affecting the operation of the instant system. Similarly, though three files are shown with simplified file names, more than three files (and likely many more than three files) with much more complex file names may be used under the instant system.

Shown is a first computer 803 having a first hard drive 809, a second computer 805 having a second hard drive 811 and a third computer 807 having a third hard drive 813. It is anticipated that prior to the operation of the system, the hard drives 809, 811, 813 are blank or have on them information that is to be overwritten.

When the first computer 803 is installed to under the instant invention, the program appliance (not shown) attached to the first computer 803 causes (based upon prior configuration or upon user input, and with reference to a storage address file 851 created as previously described) the operating system file 817 to be copied from the data storage appliance 815, where it is stored as operating system file 839, to the first hard drive 809, where it is stored as operating system file 817. Similarly a common application file 841 is copied to common application file 819. As was described with reference to method a) of the registry/configuration generation above, the operating system/common application registry and configuration file 847 is copied to the registry and configuration file 821. As previously noted a separate operating system/common registry configuration file 847 would need to be stored for each permutation of operating systems and common applications.

A second computer 805 having a second hard drive 811 may also be installed onto the same data storage appliance 815 under the instant invention. For the purposes of this example, the second hard drive 811 has installed on it the operating system file 823, the common application file 825, and an operating system registry file 827. It will be appreciated that the operating system file 839 need not be stored in two iterations on the data storage medium 815 in order for it to be used in the two different configurations on the first computer 803 and the second computer 805. Accordingly, a space savings is attained.

It will be appreciated that the example of the second computer 805 describes a registry creation process as outlined in b) above. Upon the first boot of the second computer 805, the common application file 825 installation routine will need to be executed in order to ensure that the proper additions are made to the operating system registry and configuration files 827.

A third computer 807 having a third hard drive 813 may have distributed to it several files 831, 833, 835, 837 in accordance with the invention. Those files may have their origins also in the data storage appliance 815 in the manner described. Note as to the third hard drive 813, however, that one of the files is an uncommon application file 833. Also depicted is a “Z” registry and configuration file, which may contain configuration data for the operating system file 831 and the common application file 837, but which does not contain information regarding the uncommon application file 833. The registry and configuration file 855 regarding the uncommon application file 833 may be downloaded from a separate file 853 which is then added to the operating system and common application registry file 835. This method of configuration is a combination method in accordance with f) above, including portions of a) and c).

It will be appreciated, given the description with reference to FIG. 9 and the example with reference to FIG. 8, that the steps involved in the creation of the registry and/or configuration data on the destination machine may be undertaken at the point illustrated on FIG. 5 at box 504 or may be implemented after the files are copied to the destination computer 527, without affecting the effect of the instant invention.

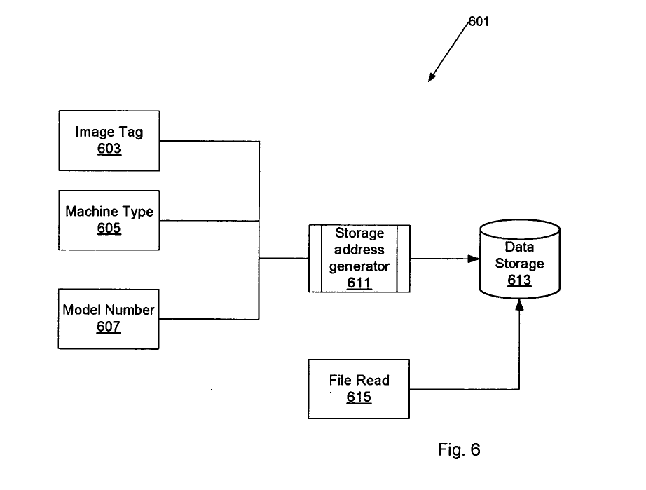

The data structure used by the data storage device and its creation is described with reference to FIG. 6, which depicts the data creation process 601 for the data to be stored on the data storage appliance 613. It is well-appreciated in the art that individual files may be read 615 from the hard drive of the subject computer and written to the data storage appliance 613 in order to accomplish the copy of the contents of the hard drive.

The instant invention, however, is suitable for use in multiple-computer environments and may be used to conduct multiple migrations or distributions involving multiple computers or software systems. Accordingly, it is necessary to designate the files written to the data storage 613 so that those files may be identified.

Accordingly, the data creation process 601 under the instant invention affords for the query of several parameters for storage on the data storage appliance 613. These parameters may be queried in some cases from the operating system, in other cases from a network data source, and in other cases directly from the user. The invention may query an image tag 603, which identifies the image. This image tag 603 may include a date and/or time stamp, operating system used, job function for which the data set applies, the language of the system, or any other number of user-defined or fixed variables. The invention may also query the machine type 605. The machine type 605 may identify the operating system and version. Other tags may include the model number 607 of the machine to which the system applies.

Each of the parameters collected is passed to a storage address generator 611 routine. The storage address generator 611 combines the parameter tags in order to form a storage address, from which all of the parameter tags may be derived during the restoration process. The storage address is stored on the data storage appliance 613 with the files read 615 from the backup computer. The files read 615 are associated with the storage address in the data storage appliance 613. This association may be physical, so that the storage address is physically located adjacent to the copies of the files from the computer. However, in another embodiment, the association is only a logical one, where the files associated with a particular storage address are identified by file name.

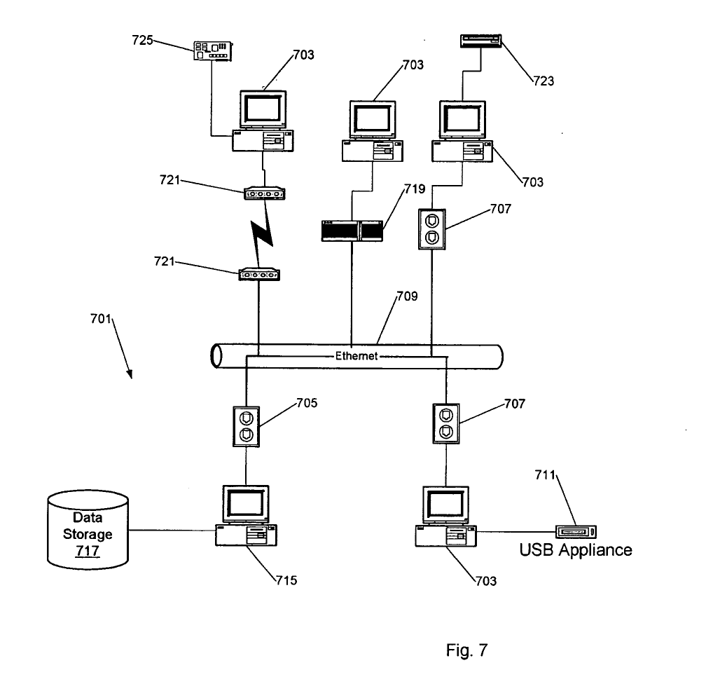

The above-described system is well-suited for implementation in a network environment where software distribution is required, as demonstrated in FIG. 7 with the extended network 701 depicted. Though the extended network 701 illustrates several types of connections for the purposes of example, those skilled in the art will appreciate those connections are shown merely for example of the flexibility of the instant disclosed system and some of its possible applications. Additional modifications and permutations may be used, all conforming to the instant invention.

The instant invention may be used with several node computers 703 that are in data communication with a common network 709. Some node computers 703 may be connected to the common network 709 directly, via ports 707 directly on the network. The node computers 703 may employ various appliances of the types previously discussed. Notably, however, not all node computers 703 will require the same type of appliance. Some node computers 703 may use USB appliances 711 as the program appliance; others may use CD ROM drives 723 or firmware cards 725 to provide the program of the instant invention to the nodes in a non-invasive fashion.

The distributed network 701 may employ a particular computer designated as a server 715. The server may be connected to the data storage appliance 717, which may be the disconnectable-type of appliance previously disclosed or may be a separate hard drive or bank of hard drives suitable for storing the backup data. The server 715 may be directly connected to the network 709 via a port 705 or by any other number of means, well-appreciated within the art.

In the distributed network 701, some of the node computers 703 may be located remotely from the network 709. In some cases, a router 719 may provide interface between the network 709 and another network system on which the node computer operates. In other cases, modems 721, satellite links or other telecommunication connections may be utilized to provide remote access from the computer node 703 to the network 709.

The instant invention provides the flexibility for use in such a distributed network system 701. It will be appreciated that the system described previously with respect to FIGS. 3, 4, and 5 will operate transparently of the distributed network system 701, even of the diversity of the one described herein. Accordingly, the instant invention provides great flexibility for use in large or small computer systems and networks.

As to the manner of operation and use of the present invention, the same is made apparent from the foregoing discussion. With respect to the above description, it is to be realized that although embodiments of specific material, representations, databases, and languages are disclosed, those enabling embodiments are illustrative and the optimum relationships for the parts of the invention are to include variations in composition, form, protocol, function, and manner of operation, which are deemed readily apparent to one skilled in the art in view of this disclosure. All relevant relationships to those illustrated in the drawings and this specification are intended to be encompassed by the present invention.

Therefore, the foregoing is considered as illustrative of the principles of the invention and since numerous modifications will readily occur to those skilled in the art, it is not desired to limit the invention to the exact construction and operation shown or described. All suitable modifications and equivalents may be resorted to, falling within the scope of the invention.

1. A system for migrating a set of software from a first computer to a second computer comprising a data storage appliance,
wherein the data storage appliance is connectable to the first computer,
wherein the data storage appliance contains an application suitable to copy the set of software from the first computer onto the data storage appliance, and
wherein the data storage appliance is connectable to the second computer, and
wherein the application is also suitable to copy the set of software from the data storage appliance to the second computer.

2. The system of claim 1 wherein the data storage appliance is connectable to the first computer via a USB port.

3. The system of claim 1 wherein the data storage appliance is connectable to the first computer via a network.

4. The system of claim 1 wherein the application is also suitable to operate without being installed on the hard drive of the first computer or the hard drive of the second computer.

5. The system of claim 1 wherein the application is further suitable to modify the set of software while it is on the data storage appliance and before such set of software is copied to the second computer.

6. The system of claim 3 wherein such modification comprises a virus scan of the set of software.

7. The system of claim 3 wherein such modification comprises an addition to the set of software.

8. The system of claim 7 wherein such addition comprises a set of drivers particular to the operation of the set of software in the environment of the second computer.

9. The system of claim 3 wherein such modification comprises modifying the order of the members of the set of software.

10. The system of claim 1 wherein the application is further suitable to disable the set of software on the first computer.

11. A removable computer-readable medium having stored thereon computer-executable instructions for performing the steps comprising:
verifying authorization to copy system files onto a destination computer;
copying software to the destination computer;
configuring the software for operation on the destination computer.

12. The removable computer-readable medium of claim 11 wherein the software copied resides on the removable computer-readable medium.

13. The removable computer-readable medium of claim 11 wherein the software copied resides on a medium connected to the computer via a network.

14. The removable computer-readable medium of claim 11 further having stored thereon a set of software files suitable for execution upon a destination computer.

15. The removable computer-readable medium of claim 11 having stored thereon computer-executable instructions, wherein the computer-executable instructions are configured so as to execute automatically upon the medium's insertion into the destination computer.

16. The removable computer-readable medium of claim 11 having stored thereon computer-executable instructions for performing the steps further comprising:
installing an operating system onto the computer from the medium; and
rebooting the computer.

17. A method for distributing an operating system software to a destination computer comprising the steps of:
connecting to the destination computer an appliance containing computer-readable medium;
executing a program stored on said medium without installation of such program on the destination computer;
copying the operating system software from a data set to the destination computer; and
copying a registry file to the destination computer.

18. The method of claim 17 further comprising the steps of:
copying a supplemental registry file to the destination computer; and
adding the supplemental registry file to the registry file,
wherein the supplemental registry file contains configuration information relating to an application installed on the destination computer.

19. The method of claim 17 further comprising the step of:
copying a supplemental registry instruction file to the destination computer; and
executing the instructions in the supplemental registry instruction file to remove entries from the registry file.
wherein the supplemental registry instruction file contains instructions to remove configuration information relating to an application not installed on the destination computer.

20. The method of claim 17 wherein the operating system is a Windows-based operating system.

21. The method of claim 17 further comprising the steps of:
copying an application to the destination computer; and
executing the installation program for the application, wherein the installation program updates the registry file with entries appropriate to the application.

22. The method of claim 17 wherein the data set is accessed via a network.

23. The method of claim 22 wherein the data set contains a storage address file which specifies the files comprising the operating system software.
